(19) United States
(12) Patent Application Publication
(10) Pub. No.: US 2012/0226606 A1
(43) Pub. Date: Sep. 6, 2012

(54) Method and system for protecting domain names

(76) Inventor: Charles P. Brown, Chicago, IL (US)

(21) Appl. No.: 13/472,246

(22) Filed: May 15, 2012

Related U.S. Application Data
(63) Continuation of application No. 09/876,408, filed on Jun. 7, 2001, now abandoned.
(60) Provisional application No. 60/210,660, filed on Jun. 9, 2000.

(51) Int. Cl. G06Q 20/14

(52) U.S. Cl. 705/40

(57) ABSTRACT

A method and system for protecting domain names. A permanent registration certificate for providing a permanent registration of a domain name can be issued. The permanent registration certificate provides a permanent registration of a domain name including perpetually determining, paying and verifying current and future renewal fees for the domain name at a public domain name registrar. A permanent web-site accessible via the Internet and associated with a domain name registration from an issued permanent registration certificate is perpetually hosted. The method and system help prevent a domain name owner from ever losing valuable domain name rights, reduce the burden and administrative overhead placed on domain name owners and more fully utilize existing and new rights associated with a domain name registration.

### CROSS REFERENCES TO RELATED APPLICATIONS

This Utility Application claims priority from U.S. Provisional Application No. 60/210,660, filed Jun. 9, 2000.

### FIELD OF THE INVENTION

This invention relates to domain name identifiers used on a computer network. More specifically it relates to a method and system for protecting domain name identifiers.

### BACKGROUND OF THE INVENTION

A domain name is a textual name that identifies one or more Internet Protocol (“IP”) addresses on a computer network like the Internet, an intranet or other computer network. As is known in the art, IP is a routing protocol designed to route traffic within a network or between networks. An IP address is issued in the format X.X.X.X, where each X represents a number between zero and 255. For example an IP address for of 178.132.103.43 may be issued for a network server.

The domain name “chuckbrown.net” may identify the IP addresses 139.142.203.45 and 139.142.203.46. Domain names make it easier for people to identify sites on the Internet and other computer networks. If a textual domain name is not used, then a person would have to remember or memorize many different IP addresses to locate sites or information on the Internet or other computer networks.

Domain names are used by people in Uniform Resource Locators (“URLs”) to identify particular web-sites on the Internet or other computer networks. Since sites on the Internet and other computer networks are identified by IP addresses and not domain names, web servers typically require assistance from a Domain Name Servers (“DNS”) to translate domain names into IP addresses.

A domain name has a suffix that indicates which top-level domain (“TLD”) it belongs to. There are only a limited number of TLDs including: (1) “.com,” for commercial business; (2) “.edu,” for educational institutions; (3) “.gov,” for government agencies; (4) “.mil,” for the military; (5) “.net,” for network organizations and (6) “.org,” for organizations including non-profit organizations. There have been recent proposals to add new TLDs including “.biz,” for businesses, “.firm,” for professional organizations such as law firms, accounting firms, and others.

Network Solutions, Inc. (“NSI”) under contract with the National Science Foundation was the exclusive registrar of TLD's from 1993-1998. The Internet Corporation or Assigned Names and Numbers (“ICANN”) was established in 1998 to move the administration of the DNS to the private sector. There are now many different approved organizations that can register domain names in association with ICANN. For example, a domain name can be registered electronically at nsi.com, register.com, namedroppers.com, domainnameregistration.com, budgetregister.com and other web-sites on the Internet.

There are a number of problems associated with the current system of registering domain names. One problem is that the current system of registration fees for Global TLDs is designed to ensure that there is money available each year from each domain to contribute to the support of the registry/registrar system and the DNS. To achieve the purpose of ensuring funding and that each domain contributes to the system each year. This system establishes a monetary self-sufficiency for the registration system, but at the cost of administrative overhead and business risk for the users of the system.

Another problem is that the pre-eminence of the dot-com (“.com)” TLD has created a de facto single global jurisdiction for trademark use. Instead of traditional common law trademark rights, which allows separate rights based on geographical separation, legitimate trademark holders can be restricted from using their trademark in the dot-com domain because someone else got it first or because another party with a conflicting trademark claim has more money to fight any trademark dispute in the courts. There are no technical barriers to allow multiple common law trademark holders sharing a domain name, but there are barriers within the current system of domain registration with the all-or-nothing ownership of domain names.

Another problem is that the current system of Internet domain ownership does not confer ownership in the traditional sense of the word. What is now referred to as “domain name ownership” is really just a right to use a domain, provided that the registration fee is current. An entity that “owns” a domain name retains the right to use that domain name by paying the registration fee on time. Otherwise the usage rights to the domain name are forfeited and the domain name returns to the general pool of domain names available for anyone to register and acquire usage rights.

Another problem is that domain names have become valuable entities unto themselves, far out of proportion in value to the cost of an annual registration fee. Some domains have a commercial value of millions of dollars, but non-payment of a single $35 payment can result in the loss of valuable rights and will disconnect a web-site at a domain name address.

Another problem with the current system of renewing domain names is that it places a high administrative cost on domain name owners to track and issue small payments. Large corporations typically have many domain names with administrative and payment contacts spread throughout divisions and departments. This distributed rather than centralized control increases the chances of one or more domains could expire. In addition, individuals listed as administrative and payment contacts could leave an organization thereby preventing the proper individual to be timely located to to handle problems with, or renewals of domain names.

Another problem is that there is no system of accountability or defined procedures for the registrars to guarantee that the renewal notices for a domain are ever issued or received to ensure that the individuals responsible for the domain are notified. In the case of no response to a renewal notice, there are no procedural guarantees are in place to protect the rights of the domain name owner. There is also a lack of survivorship or beneficiary rights from the domain name registrars for individual domain name holders who die.

Another problem is the maintenance of domain rights beyond the term of currently paid registration fees. The current domain name registration system currently sends renewal notices via electronic mail (“e-mail”). In today's society, individuals frequently change Internet Service Providers, and hence frequently change e-mail addresses. In addition, even business organizations may change e-mail addresses due to mergers, acquisitions, buyouts, re-organizations, bankruptcy, etc. If a domain name owner changes e-mail addresses between registration periods, the possibility exists that the domain name payment notice will not be received, increasing the possibility of the registration period lapsing.

Another problem is that Internet Service Providers (“ISP”) and other organizations that host web-sites associated with a domain name frequently go out of business. Many domain name owners would like the ability to maintain a permanent web-site on the Internet without regard to the underlying web-site host.

Another problem is that under the current system of domain rights, domain ownership or access rights exist on an all-or-nothing basis. The named registrant has all rights to the use of the domain name and any web or e-mail address that is in that domain. Therefore, there is limited opportunity to take advantage of additional possible uses of domain name registrations.

Another problem is that under the current system of investment in domain names, domain registrants offer domains for sale either directly or through domain reseller web sites such as GreatDomains.com or Afternic.com. These sites handle thousands of sales, but all sales are for a full interest in the domain and require a transfer of the domain from the investor to the new registrant. The current system defines an inefficient market based on an all-or-nothing ownership structure that does not allow ownership interests in domain names to be shared hr multiple parties.

Another problem is the danger of hacking or tampering or errors at the registrar or registry level. Domain names have been hacked or hijacked from legitimate owners. Even when the domain names can be recovered, substantial fees including legal fees can be incurred by the legitimate owner.

Thus, it is desirable to provide a method to permanently protect and utilize domain name registrations. The method should help prevent a domain name owner from ever losing valuable domain name rights and fully utilize existing and new rights associated with a domain name registration.

### SUMMARY OF THE INVENTION

In accordance with preferred embodiments of the present invention, some of the problems associated with protecting domain names are overcome. A method and system protecting domain names is presented.

One aspect of the invention includes a method for issuing a permanent registration certificate for providing a permanent registration of a domain name. The permanent registration certificate provides a permanent registration of a domain name including perpetually determining, paying and verifying current and future renewal fees for the domain name at a public domain name registrar.

Another aspect of the invention includes a method for providing permanent registration of domain names using the permanent registration certificate.

Another aspect of the invention includes a method for perpetually hosting a web-site accessible via the Internet and associated with a domain name registration from an issued permanent registration certificate.

Another aspect of the invention includes a method for providing co-use of a domain name for which a permanent registration certificate has been issued.

The method and system described herein may help prevent a domain name owner from ever losing valuable domain name rights, reduce the burden and administrative overhead placed on domain name owners and more fully utilize existing and new rights associated with a domain name registration.

The foregoing and other features and advantages of embodiments of the present invention will be more readily apparent from the following detailed description. The detail description proceeds with references to accompanying drawings.

### BRIEF DESCRIPTION OF THE DRAWINGS

Embodiments of the present invention are described with reference to the following drawings, wherein:

FIG. 1 is a block diagram illustrating an exemplary domain name protection system;

FIG. 2 is a flow diagram illustrating a method for protecting domain name registrations with a permanent registration certificate;

FIGS. 3A and 313 are a flow diagram illustrating a method for providing permanent registration of domain name registrations;

FIG. 4 is a block diagram illustrating an exemplary data flow associated with the method of FIG. 3;

FIG. 5 is a flow diagram illustrating a method for providing a permanent web-site; and

FIG. 6 is a flow diagram illustrating a method for providing a co-use of a permanent domain name.

### DETAILED DESCRIPTION OF THE PRESENT INVENTION

### Exemplary Domain Name Protection System

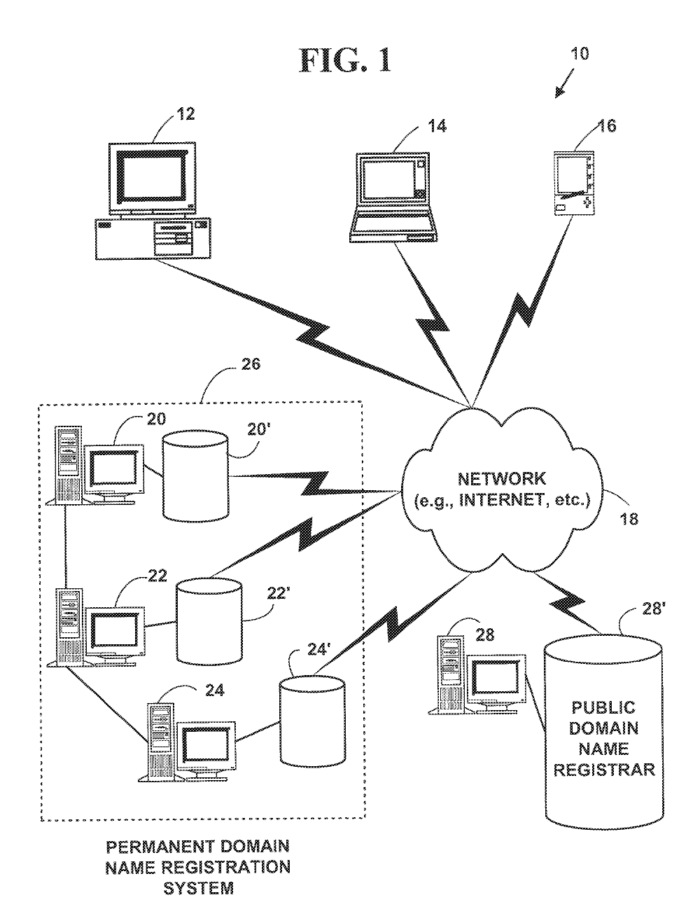

FIG. 1 is a block diagram illustrating an exemplary domain name protection system 10. The exemplary domain name system 10 includes one or more client network devices 12, 14, 16 (only three of which are illustrated). The client network devices 14, 16 include, but are not limited to, personal computers, wireless devices, mobile phones, personal information devices, personal digital assistants, hand-held devices, network appliances, pagers, and other types of electronic devices. However, the present invention is not limited to these devices and more or fewer types of client electronic devices can also be used. The client network devices 12, 14, 16 are in communications with a computer network 18 (e.g., the Internet, intranet, etc.). The communication includes, but is not limited to, communications over a wire connected to the client network devices, wireless communications, and other types of communications.

Plural server network devices 20, 22, 24 (only three of which are illustrated) are associated with one or more associated databases are components of a permanent domain name registration system 26. The permanent domain name registration system includes a Purchase/Payment server 20, an Administrative server 22 and a Web-site hosting server 24. The plural network devices 20, 22 and 24 provide system for allowing a “permanent registration” of a domain name. However, more or fewer server network devices can also be used and the present invention is not limited to the illustrated components.

In addition, the plural server network devices are illustrated as separate network devices and the functionality of the server network devices can be split into additional servers, or combined into fewer servers. The plural server network devices 20, 22, 24 may also include duplicate or “mirrored” server network devices with associate plural databases to provide fault tolerance.

In another embodiment of the present invention, the plural server network devices 20, 22, 24 can also be combined into one server network device with associated plural databases. In such an embodiment, the single server network device and associated plural databases would include the necessary functionality to protect registered domain names and may include a duplicate or “mirrored” server network device with associated plural databases to provide fault tolerance.

The Purchase/Payment server 20 accepts domain name registration information and handles payment of current and future renewal fees for a domain name. The administrative server 22 helps ensures that the payment has been received by the public domain name registrar by checking for the updated next payment date, verifying payments, determining and solving payment and information discrepancies, etc. The Web-site hosting server 24 allows a domain name for which a permanent registration has been obtained to have a permanent presence on the computer network 18. Thus, the Web-site hosting server 24 can “permanently” host a web-site.

An operating environment for components of the domain name protection system 10 for preferred embodiments of the present invention include a processing system with at least one high speed Central Processing Unit (“CPU”) and memory. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical signals or biological signals by the CPU. An electrical system represents data bits which cause a resulting transformation or reduction of the electrical signals, and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”)) mass storage system readable by the CPU. The computer readable medium includes cooperating or interconnected computer readable medium, which exist exclusively on the processing system or be distributed among multiple interconnected processing systems that may be local or remote to the processing system.

### Protecting a Domain Name Registration

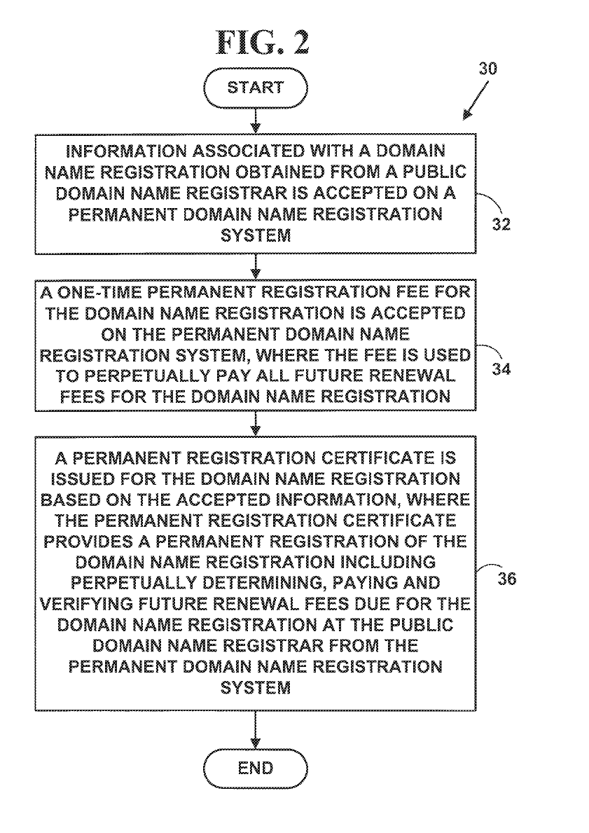

FIG. 2 is a flow diagram illustrating a Method 30 for protecting domain name registrations with a permanent registration certificate. At Step 32, information associated with a domain name registration obtained from a public domain name registrar is accepted on a permanent domain name registration system. At Step 34, a one-time permanent registration fee for the domain name registration is accepted on the permanent domain name registration system. At Step 36, a permanent registration certificate is issued for the domain name registration based on the accepted information. The permanent registration certificate provides a permanent registration of the domain name registration including perpetually determining, paying and verifying future renewal fees for the domain name registration at the public domain name registrar from the permanent domain name registration system.

Method 30 may also comprise any or all of the additional steps of: issuing a domain name registration title, issuing an insurance policy, issuing plural ownership shares, issuing leases or sub-leases, issuing co-ownership certificates, or creating new or additional rights in the domain name associated with the permanent registration certificate.

The domain name registration title (“Domain Title”) covers financial losses associated with not properly renewing a domain name registration. The Domain Title can be used alone, or in combination with the insurance policy. In one embodiment of the present invention, the Domain Tide is implemented as a contract. However, the present invention is not limited to such an embodiment, and other embodiments can also be used.

The insurance policy covers financial losses associated with not properly renewing a domain name registration. The insurance policy provides compensation for any financial losses associated with accidental disruption or loss of domain name rights use. The insurance policy also allows trustees and/or beneficiaries for permanent domain name registrations to be named to ensure that the wishes of domain name registration holder are honored, regardless of situations resulting from inaction, disability or death.

The plural ownership shares allow ownership interests to be sold in the permanent domain name registration. In one embodiment of the present invention, the plural shares are implemented as contracts designed to support the specific features of equity sharing, co-ownership or “stock” ownership in domain names. However, the present invention is not limited to such an embodiment, and other embodiments can also be used.

Multiple share owners with defined shared rights could co-exist in a similar way. For example, in the world of real estate, condominium or apartment owners share clearly defined ownership rights with other owners within a larger property which in itself is a separate legal entity. The holder of shares can sell shares in a domain name to investors for income or appreciation or to make many types of ownership and sharing of domain names possible in ways that are not currently viable.

Issuing leases or sub-leases for a domain, name associated with the permanent registration certificate allows ownership interests to be reserved for a limited duration in a domain name registration associated with the permanent registration certificate. The is holder of a Domain Title could lease the use of the domain name or portions of it to another entity for a period of any length, while providing rights including renewal rights and right of first refusal. Such a system of leasing could not be considered reliable under the current system because the current “right holder” could not guarantee their ability to confer those rights beyond the term of currently paid domain name registration fees.

Issuing co-ownership certificates for the domain name associated with the permanent registration certificate allows two or more entities in two or more different locations to co-own one domain name registration associated with the permanent registration certificate. For example, two common law trademark owners located in different parts of the U.S. or in different parts of the world could co-own a domain name registration.

In one embodiment of the present invention, creating new or additional rights includes creating additional contract layers on top of the permanent domain name registration system 26. This new contract layers may require a third-party to guarantee the new or additional rights associated with the permanent registration certificate can be enforced.

Method 30 is illustrated with an exemplary embodiment. However, the present invention is not limited to this exemplary embodiment and other embodiments can also to be used with Method 30.

At Step 32, information associated with a domain name registration obtained from a public domain name registrar 28 such as NSI, or other ICAAN approved registrar is accepted on the permanent domain name registration system 26. In another embodiment of the present invention, the information can also be accepted from a private domain name registrar (e.g., a private domain name registrar for an intranet or other private computer network). In another embodiment of the present invention, the permanent domain name registration system 26 could also accept information from a user and issue its own domain name registration for either a public or a private network 18, in another embodiment of the present invention, the permanent domain name registration system 26 could also obtain a domain name registration from a public domain name registrar for a user.

In one embodiment of the present invention, the accepted information includes the domain name, domain name owner, address, domain name server information and other information. However, more or fewer types of information can be accepted and the present invention is not limited to this list.

In one embodiment of the present invention, at Step 32 a user enters required information regarding a registered domain name that is accepted into the Purchase/Payment server 20. In another embodiment of the present invention, the Purchase/Payment server 20 accepts required information directly from the public domain name registrar 28.

In one embodiment of the present invention, the Purchase/Payment server 20 dynamically checks the information with the appropriate public domain name registrar after it has been accepted. The information is checked to determine if the information is accurate, has not been tampered with, or has not been altered without explicit notification or permission of either the original domain name registrant and/or the public domain name registrar 28. This provides an additional security measure for the permanent domain name registration system 26.

At Step 34, a one-time permanent registration fee for the domain name registration is accepted on the permanent domain name registration system 26. In one embodiment of the present invention, Step 34 includes accepting a one-time permanent registration fee electronically over the Internet 18 on Purchase/Payment server 20. The fee is accepted electronically by accepting credit-card information, debit-card information, checking account information, electronic funds transfer information, or other types of electronic payment or e-commerce payment information.

In another embodiment of the present invention, the fee can be accepted by administrative or support personal via telephone by collecting appropriate credit or debit information from a user. In another embodiment of the present invention, the fee can be accepted via check, money order, etc. sent via the U.S. mail, express mail, etc. in embodiments where the one-time permanent registration fee is not accepted electronically, the permanent registration certificate described below is not issued until the fee payment has been verified (e.g., waiting for a check to clear, etc.).

In one embodiment of the present invention, the one-time permanent registration fee is added to financial instruments whose profits or interest is used to perpetually pay future renewal fees for the domain name registration. For example, the financial instrument can include an interest bearing account, a certificate of deposit, mutual funds, stocks, bonds, annuities, or other type of financial instrument.

In one embodiment, the one-time permanent registration fee is selected such that a first portion of the fee will be used to satisfy current registration fees and administrative costs at the public domain name registrar 28. A second portion of the fee is enough to generate interest or other income through investments and/or the sale of additional goods or services to pay all current and future administrative costs and future registration fees in perpetuity for the domain name registration on the permanent domain name registration system 26. One skilled in the art can determine that the one-time permanent registration fee can be divided into various other portions that are distributed in various ways to cover costs and fees on the permanent domain name registration system 26 and the public domain name registrar 28.

In one embodiment of the present invention, the one-time permanent registration fee is selected based on contractual or other agreements with one or more public domain name registrars. For example, a first user may have obtained a domain name registration from a first public domain name registrar that has a contractual agreement with the permanent domain name registration system 26 owners. The first public domain name registrar may have agreed to allow renewal of a domain name registrar perpetually for $10 per year. The one-time permanent registration fee would then be selected based on the $10 per year renewal fee. If a second public domain name registrar agreed to allow renewal of domain names it registered for $8 per year, a different one-time permanent registration fee could be selected. Various types of contractual or other legal agreements between public domain name registrars and the permanent domain name registration system 26 allow the one-time permanent registration fee to be variable and flexible.

The accepted information is stored in one or more databases 20′, 22′ and/or 24′ associated with the permanent domain name registration system 26. Table 1 illustrates exemplary information accepted and stored for a domain name registration. However, the accepted and stored information is exemplary only and more or less information can also be stored.

TABLE 1

Permanent Registration Certificate Number: 13579246
Insurance Policy Number: xxx
Domain Title Number: xxx
Domain Share Certificate Number: xxx
Payment Account Number: xxx
Lease/Sublease Number: xxx
Co-User Number: xxx
Co-Owner Number: xxx
Contract Number: xxx
Registrar(s): xxx
US Domain Name: permanentweb.com
Administrative Contact: Chuck Brown
Hamlin Computer Technology, Inc.
5100 Hamlin Avenue
Chicago, Illinois 60625 US Phone- 773-463-2051 Fax-
Technical Contact: Thomas Brown
Global Logistics Corp Domain Management Division
Port, Vila, 1 VU
Phone- +64 21-360-006
Fax- +1-801-749-2901
Record updated on 2000-08-24 00:00:00.
Record created on 2000-08-24.
Record expires on 2001-08-24.
Database last updated on 2001-05-31 10:13:36 EST.
Domain servers in listed order:
NS.BULKREGISTER.COM 216.147.43.234
NS2.BULKREGISTER.COM 216.147.1.164

At Step 36, a permanent registration certificate is issued for the domain name registration. The permanent registration certificate provides a permanent registration of the domain name registration including perpetually determining, paying and verifying future renewal fees for the domain name registration at the public domain name registrar 28 from the permanent domain name registration system 26.

In one embodiment of the present invention, an electronic permanent registration certificate is created from the accepted information and forwarded to the domain name owner electronically. The electronic permanent registration certificate is stored on one or more databases 20′, 22′, 24′ associated with the permanent domain name registration system 26. The electronic permanent registration certificate can be viewed via computer network 18 (e.g., with a web-browser). Access to the electronic permanent registration certificate may be limited to the domain name owner(s) and protected by one or more security measures (e.g., login, password, encryption, etc.).

In another embodiment of the present invention, a paper permanent registration certificate is issued at Step 38. The accepted information used to create the paper permanent registration certificate is stored on one or more databases 20′, 22′, 24′ associated with the permanent domain name registration system. The paper permanent registration certificate is then forwarded to the domain name owner for safekeeping. However, the present invention is not limited to such embodiments and the present invention can be used with other types of permanent registration certificates.

Method 30 enables domain name owners to establish permanent rights to a domain name registration and provide a process to help reduce the risk that a domain name registration will lapse because of error or inaction, or other unforeseen circumstances.

### Providing Permanent Registration of Domain Names

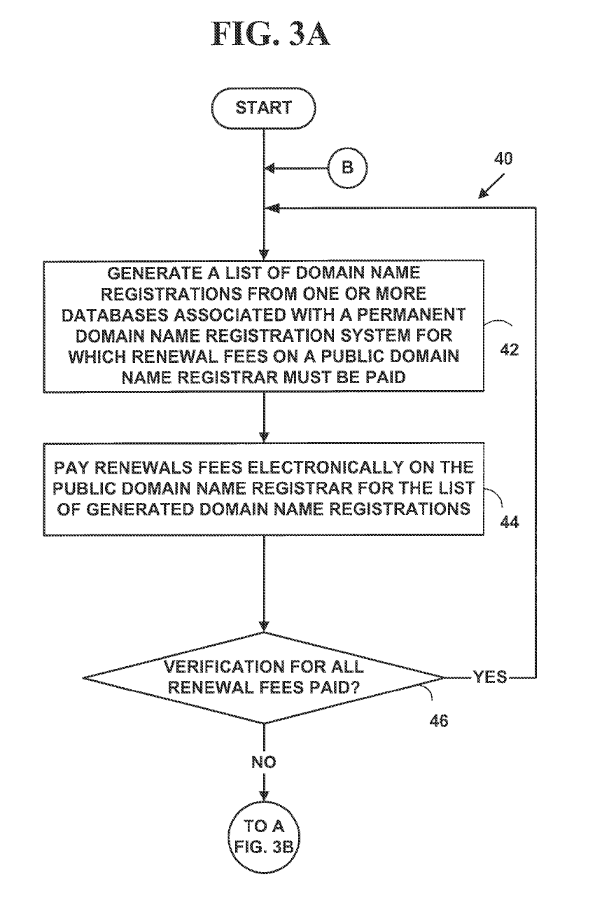

FIGS. 3A and 3B are a flow diagram illustrating a Method 40 for providing permanent registration of a domain name registrations. In FIG. 3A at Step 42, a list of domain name registrations is generated from one or more databases associated with a permanent domain name registration system for which renewal fees on a public domain name registrar must be paid. The generated list of domain name registrations includes plural domain name registrations for which plural permanent registration certificates have been purchased. The permanent registration certificate provides a permanent registration of the domain name registration including perpetually determining, paying and verifying current and future renewal fees for the domain name registration at the public domain name registrar from the permanent domain name registration system. At Step 44, renewals fees are paid electronically on the public domain name registrar for the list of generated domain name registrations. At Step 46, a query is conducted at the public domain register to determine whether all of the domain name registrations from the generated list of domain name registration have been renewed on the public domain name registrar.

If all of the domain name registration have not been renewed on the public domain registrar, then in FIG. 3B at Step 48, additional renewal fees are transferred for any domain name registrations that have not been renewed on the public domain name registrar, thereby ensuring renewal of domain name registrations. At Step 50, administrators at the permanent domain name registration system and the public domain name registrar are notified of any renewal fee discrepancies. Steps 42-46 are repeated periodically and perpetually to ensure that all domain name registrations on the permanent domain name registration system are properly renewed.

If all of the domain name registration have been renewed on the public domain registrar at Step 46, then Steps 42-46 are repeated periodically and perpetually to ensure that all domain name registrations on the permanent domain name registration system are properly renewed.

Method 40 is illustrated with an exemplary embodiment. However, the present invention is not limited to this exemplary embodiment and other embodiments can also be used with Method 40.

At Step 42, a list of domain name registrations is periodically generated from one or more databases 20′ 22′ 24′ associated with a permanent domain name registration system 26 for which renewal fees on a public domain name registrar 28 must be paid.

The permanent domain name registration system 26 maintains lists of domain name registrations and ensures that payments are transferred to an appropriate public domain name registrar 28 in advance of the due date without fail. The permanent domain name registration system 26 is based on redundant databases with checks and balances and automatic pre-payment and verification of registration fees. The permanent domain name registration system helps reduce or even eliminate any possibility of an accidental domain name registration deletion or non-payment. The permanent domain name registration system 26 also helps satisfy requirements of an insurance company that may be issuing business interruption insurance associated with the permanent registration certificate.

In one embodiment of the present invention, the permanent domain name registration system 26 cross-checks domain name registration information from three databases 20′, 22′ and 28′ and generates the list at Step 42. One database is a Purchase/Payment Database 20. Another database is an Administration Database 22. These to databases 20′ and 22′ are maintained by the permanent domain name registration system 26. The third database 28′ is a database maintained by public domain name registrar 28 that issues the actual domain name registrations. The third database 28 is may be multiple databases for one public domain name registrar, or multiple databases for multiple public domain name registrars. The third database 28′ may also include one or more database for a private domain name registrar.

In one embodiment of the present invention, the Purchase/Payment and Administration databases 20′, 22′ will have separate administrators and controls to ensure that an error on the part of one server, database or person will not result in a lost domain name registration or a missed payment. Automatic messages will be sent to the administrators of all three databases in the case of any discrepancies between the databases. These messages will be repeated until the problem has been resolved. The destinations, frequency and escalation procedures for those messages are configurable.

In one embodiment of the present invention, the Purchase/Payment database 20′ maintains a full list of covered domain name registration and renewal dates and is responsible for generating payment lists at Step 42 for upcoming months and for receiving the renewal notifications from the public domain name registrar 28. However, the present invention is not limited to this embodiment and other components of the permanent domain name registration system 26 can generate lists at Step 42.

In one embodiment of the present invention, the Purchase/Payment server 20 generates list of renewals due in the next month from the Purchase/Payment database 20′ For example, renewals due in May will be generated by the first day of April.

The Administrative database 22′ also includes a list of all covered domain name registration with the information included in the Purchase/Payment database 20. In addition, this database includes full client, account information including login security information and account history.

The third database 28 is an existing external database maintained by the public domain name registrar 28. The data it maintains is includes information returned by a “whois” check on a domain name. As is known in the art, whois is an Internet-based directory service for looking up names of owners of domain name registrations.

Returning to FIG. 3A at Step 44, renewals fees are paid electronically on the public domain name registrar for the list of generated domain name registrations. In another embodiment of the present invention, renewal fees can be paid by other methods as was described above for accepting payment for a permanent registration certificate (e.g., via the telephone, via the U.S. mail, etc.). The present invention is not limited to paying renewal fees electronically.

The renewal fees paid at Step 44 can be paid in a number of different manners based on a number of different factors. In one embodiment, the renewal fees are paid electronically only for domain name registrations that will expire in the next month. In another embodiment of the present invention, the renewal fees are paid electronically for all domain name registration that will expire in a pre-determined time period (e.g., 3 months). In another embodiment of the present invention, the additional renewal fees are also paid electronically when a value of a renewal fee account at the public domain name registrar falls below a pre-determined amount.

The payment system may also include an advanced payment balance or buffer at each public domain name registrar 28 or selected public domain name registrars. The purpose of the advanced buffer is to ensure that the enough money will be on hand for the registrar to draw down from as the covered domains come due. The buffer will provide an additional level of assurance that in the case of a missed payment by the

Administrative server 22 and/or Purchase/Payment server 20, and/or the public domain name registrar 28 will still be able to draw the required payment from the excess funds in the payment buffer. When the payment system checks the balance of the payment buffer and finds a discrepancy, the database administrators will be notified and required to find the reason for the missed payment or missed domain name and make the corrections and balance the account.

At Step 46, a query is conducted at the public domain register 28 to determine whether all of the domain name registrations from the generated list of domain name registrations have been renewed on the public domain name registrar 28.

In one embodiment of the present invention, the Administrative server 22 conducts the query at Step 46. However, the present invention, is not limited to such an embodiment and the query conducted at Step 46 can be conducted from other components of the permanent domain name registration system 26.

In one embodiment of the present invention, the query at Step 46 is conducted on databases on the permanent domain name registration system 26 and on the public domain name registrar 28. In such an embodiment, the results are compared to immediately determine an inconsistencies and the appropriate database administrators are notified.

If there are any domain names from the list that have not be marked as renewed by the public domain name registrar 28, the Administrative server 22 flags any such domain names. The Administrative server 22 sends a message to the Purchase/Payment database 20′ to transfer the additional funds to the public domain name registrar 28.

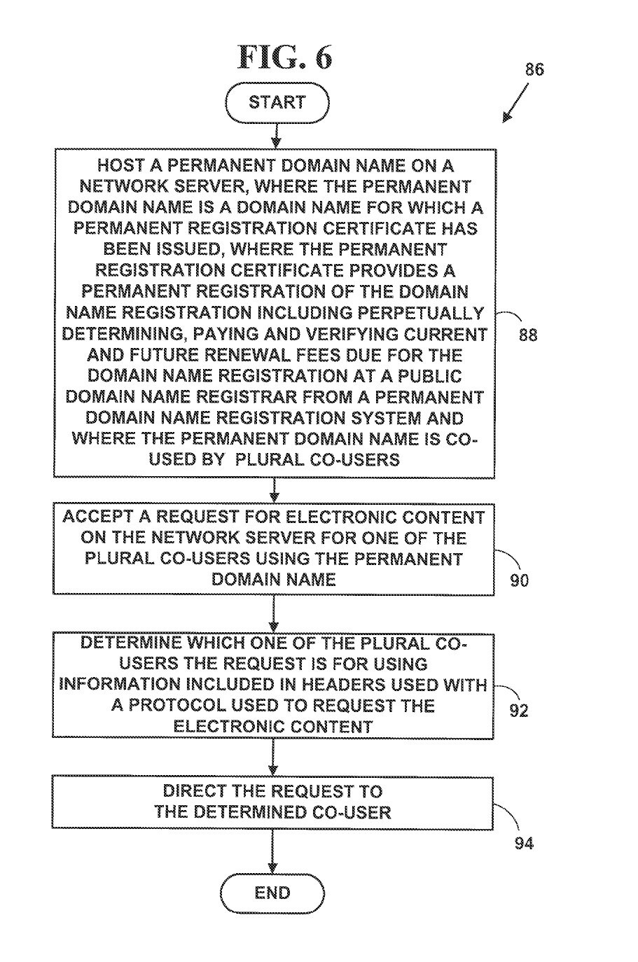

At Step 48 of FIG. 313, additional renewal fees are transferred by the Purchase/Payment server 20 for any domain name registrations that have not been renewed on the public domain name registrar 28, thereby ensuring renewal of domain name registrations. At Step 50, the Administrative server 22 notifies administrators at the permanent domain name registration system 26 and the public domain name registrar 28 of any renewal fee discrepancies.

If the query at Step 46 shows that all of the domain name registrations from the generated list of domain name registrations have been renewed on the public domain name registrar 28, then processing continues periodically at Step 42 of FIG. 3A.

If the Administrative database 22′ includes any domain name registrations that it shows as expiring in the following month for which the public domain name registrar 28 does not show a renewal fee is due, the Administrative server 22 sends a message to the Purchase/Payment database 20′ to transfer the additional funds. Additionally, administrators for both databases are notified of the discrepancy.

In one embodiment of the present invention, at the end of each month, the Purchase/Payment server 20 optionally checks the balance in the public domain name registrar account 54 to verify that an expected balance is present. However, the present invention is not limited to this embodiment. In the case of an unexpected balance, both administrators are notified.

Steps 42-46 (FIG. 3A) are repeated on a periodic basis. For example, weekly a series of automated checks will be run to verify that the public domain name registrar database 28′, the Purchase/Payment database 20′ and the Administrative database 22′ are all in agreement with respect to domain name registrations and renewal dates. If any discrepancies are found, the respective administrators are notified. However, the present invention, is not limited to a weekly series of automated checks and virtually any larger or smaller time period could be used to repeat Steps 42-46 (e.g, minutes, hours, days, etc.).

The integrity of the permanent domain name registration system 26 is also monitored frequently. Public domain name registrar databases 28 are also monitored frequently to determine any changes made by a domain name owner. Any determined changes are propagated to, or corrected in databases 20′, 22′, 24′ in the permanent domain name registration system 26 and/or public domain name registrar database 28. Public domain name registrar databases 28′ and databases 20′, 22′, 24′ are also monitored frequently to determine if any improper changes have been made by hackers or hijackers.

### Exemplary Data Flow for Providing Permanent Registration of Domain Names

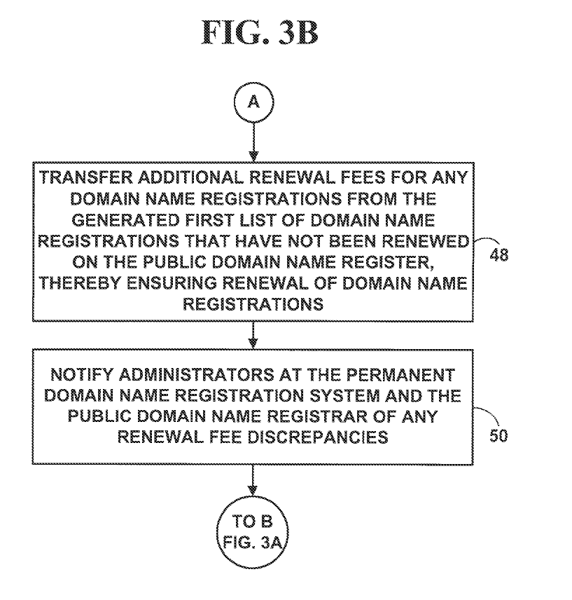

FIG. 4 is a block diagram illustrating an exemplary data flow 54 associated with Method 40 of FIG. 3. In FIG. 3A at Step 42, a list of domain name registrations 56 is generated by the Purchase/Payment Server 20 from one or more databases 20′, 22′ and 24′ associated with a permanent domain name registration system 26 for which renewal fees on a public domain name registrar 28 must be paid. This is illustrated by Line 58.

At Step 44, renewals fees are paid electronically to an account 60 for the public domain name registrar 28 for the list of generated domain name registrations 56. This is illustrated by Line 62.

At Step 46, a query is conducted from the Administrative Server 28 at the public domain register 28 to determine whether all of the domain name registrations from the generated list of domain name registrations 56 have been renewed on the public domain name registrar 28. This is illustrated by Line 64.

If there are any domain names from the list that have not be marked as renewed by the public domain name registrar 28, the Administrative server 22 flags any such domain names. The Administrative server 22 sends a message to the Purchase/Payment server 20 to transfer the additional funds to the public domain name registrar 28. This is illustrated by Line 66.

At Step 48 of FIG. 3B, additional renewal fees are transferred by the Purchase/Payment server 20 for any domain name registrations that have not been renewed on the public domain name registrar 28, thereby ensuring renewal of domain name registrations. This is illustrated by Line 68. At Step 50, the Administrative server 22 notifies the Purchase/Payment Server 22 at the permanent domain name registration system 26 and the public domain name registrar server 28 of any renewal fee discrepancies. This is illustrated by lines 70 and 70′.

### Providing a Permanent Web-Site for Permanently Registered Domain Names

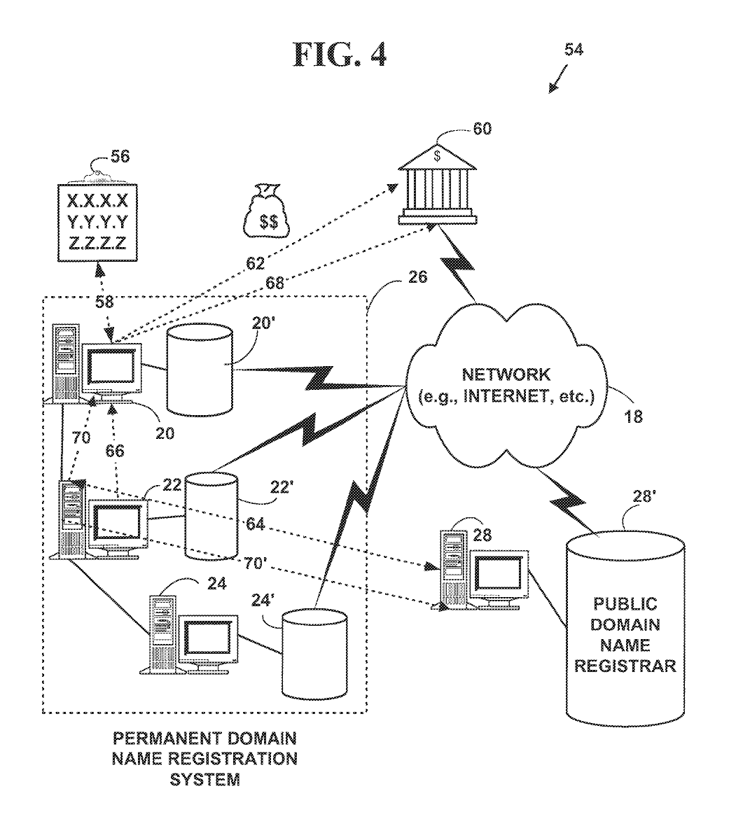

FIG. 5 is a flow diagram illustrating a Method 74 for providing a permanent web-site. At Step 76, a domain name for which a permanent registration certificate has been issued is accepted on a permanent domain name registration system. The permanent registration certificate provides a permanent registration of the domain name including perpetually determining, paying and verifying current and future renewal fees for the do nam name at a public domain name registrar from the permanent domain name registration system. At Step 78, electronic content for a web-site to be associated with the domain name is accepted. At Step 80, a one-time permanent web-site fee for hosting the domain name on the permanent domain name registration system is accepted. The one-time permanent web-site fee is used to perpetually host the domain name on the permanent domain name registration system. At Step 82, a web-site accessible via the Internet associated with the domain name is perpetually hosted on the permanent domain name system.

Method 74 is illustrated with an exemplary embodiment. However, the present invention is not limited to this exemplary embodiment and other embodiments can also be used with Method 74.

At Step 76, a domain name for which a permanent registration certificate has been issued is accepted on the permanent domain name registration system 26. The permanent registration certificate provides a permanent registration of the domain name including perpetually determining, paying and verifying current and future renewal fees for the domain name at a public domain name registrar from the permanent domain name registration system. For example, a permanent registration certificate issued via Method 30 (FIG. 2).

At Step 78, electronic content for a permanent web-site to be associated with the domain name is accepted on the permanent domain name registration system 26. In one embodiment of the present invention, the electronic content is accepted via permanent web-site server 24 and stored in one or more permanent web-site databases 24′. The electronic content accepted includes text, graphics, audio, video, and other electronic content.

At Step 80, a one-time permanent web-site fee for hosting the domain name on the permanent domain name registration system 26 is accepted via the Purchase/Payment database 20. The payment is recorded on the Administrative database 22. The one-time permanent web-site fee is used to perpetually host the domain name on the permanent domain name registration system 26.

As is known in the art, hosting a web-site includes providing hardware and software necessary to allow communications with the Internet and to service request/responses for electronic content on the web-site. In one embodiment of the present invention, the one-time permanent web-she fee is added to a financial instrument whose profits or interest is used to perpetually pay administrative costs to host a web-site for the domain name accessible via the Internet on the permanent domain name system. However, the present invention is not limited to such an embodiment.

At Step 82, a permanent web-site accessible via the Internet 18 associated with the domain name is perpetually hosted on the permanent domain name system 26. The perpetual hosting of the web-site helps provide a “permanent” presence on the Internet via a domain name by perpetually maintaining a web-site associated with the domain name and perpetually determining, paying and verifying current and future renewal fees for the domain name at a public domain name registrar from the permanent domain name registration system using a permanent registration certificate issued for the domain name.

In one embodiment the permanent web-site is hosted directly by the permanent web-site server 24 on the permanent domain name registration system 26.

In another embodiment of the present invention, the “permanent web-site” is not hosted from the permanent domain name registration system 26. In such an embodiment the permanent web-site is hosted by another host. However, the permanent domain name registration system 26 continually monitors the host to ensure the host is viable and has is not having problems or has gone out of business.

In another embodiment of the present invention, the permanent web-site server 24 hosts the domain name associated with the permanent web-site (e.g., by accepting queries to a published IP address), but maps or otherwise re-directs any queries from the computer network 18 to an appropriate host that is actually hosting the permanent web-site.

The permanent web-site server 24 also frequently monitors the host to update any new content stored on the permanent web-site. In one embodiment of the present invention, any new content added to the permanent web-site must be sent to the permanent web-site server 24 by the permanent web-site. In another embodiment of the present invention, the permanent web-site server 24 automatically monitors the permanent web-site and automatically downloads and stores any new content in the permanent web-site database 24′ to keep the permanent web-site database up-to-date. If the host is having problems or has gone out of business, the permanent web-site is then immediately hosted via permanent web-site server 24.

If a host is having problems or has gone out of business, the IP address identifying the domain name for the permanent web-site at the host can be immediately re-mapped to a new IP address on the permanent web-site server 24. Thus, the permanent web-site can permanently hosted by the permanent domain name registration system 26 in a variety of different ways.

### Co-Using a Permanent Domain Name

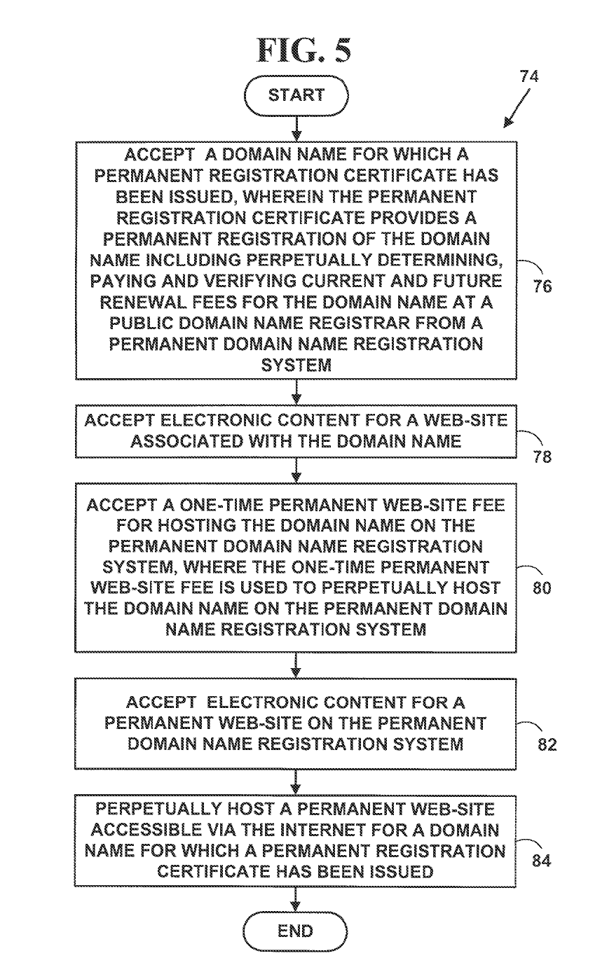

FIG. 6 is a flow diagram illustrating a Method 86 for providing a co-use of a permanent domain name. At Step 88, a permanent domain name is hosted on a network server. The permanent domain name is a domain name for which a permanent registration certificate has been issued. The permanent registration certificate provides a permanent registration of the domain name registration including perpetually determining, paying and verifying current and future renewal fees due for the domain name registration at a public, domain name registrar from a permanent domain name registration system. The permanent domain name is co-used by plural co-users. At Step 90, a request for electronic content is accepted on the network server for one of the plural co-users using the permanent domain name. At Step 92, a determination is made to determine which one of the plural co-users the request is for using information included in headers used with a protocol used to request the electronic content. At Step 94, the request is directed to the determined co-user.

The plural co-users can be co-owners of the permanent domain name. The plural co-users can also be leasing or sub-leasing the permanent domain name for one or more permanent domain name owners. Co-ownership and leasing/sub-leasing of a permanent domain name was discussed above.

Method 86 is illustrated with an exemplary embodiment. However, the present invention is not limited to this exemplary embodiment and other embodiments can also be used with Method 86.

In such an embodiment at Step 88, a permanent domain name is hosted on the Web-site hosting server 24. The permanent domain name is a domain name for which a permanent domain name registration certificate has been issued (e.g., with Method 30 of FIG. 2). The permanent domain name is co-used by plural co-users. At Step 90, a request for electronic content is accepted on the Web-site hosting server 24 for one of the plural co-users using the permanent domain name. At Step 92, a determination is made to determine which one of the plural co-users the request for electronic content is for using information included in headers used with a protocol used to request the electronic content. In one embodiment of the present invention, the determination made at Step 92 includes making a determination using an IP address in a header for a protocol used to request the electronic content. However, the present invention is not limited to such an embodiment and other determinations can also be used at Step 92.

In one embodiment of the present invention, the protocol used the electronic content can include, but is not limited to, the Hyper Text Transfer Protocol (“HTTP”), File Transfer Protocol (“FTP”), Simple Mail Transfer Protocol (“SMTP”), a variety of other protocols from the Internet Protocol suite, or other types of networking protocols.

In one embodiment of the present invention, the Web-site hosting server 24 maintains tables for co-users of a permanent domain name. The tables include specific IP addresses or ranges of IP addresses for which a co-user of a permanent domain name will accept requests for electronic content. These tables allow two or more co-users to co-use the same permanent domain name from different geographic regions, or based on other pre-determined criteria (e.g., cooperative agreements, contracts, advertising or other fees, etc.). At Step 94, the request is directed to the determined co-user by the Web-site hosting server 24.

In one embodiment of the present invention, Method 86 helps allow co-use of a permanent domain name, thus helping to reduce trademark disputes or other business disputes. Business disputes can also be resolved with Method 86 by a neutral third-party outside the permanent domain name owners, the permanent domain name registration system 26 or the public domain name registrar 28.

As an example, to reduce trademark disputes, suppose a first co-user was using a permanent domain name in based on a common law trademark in Illinois and a second co-user was using the same permanent domain name in California. The Web-site hosting server 24 could then use pre-determined IP addresses or ranges of IP addresses to determine whether a request is for the first or second co-user. The IP addresses are used to determine a geographic region the request came from, and then direct the request to the co-user that in the geographic region closest to the requester. Conflicts are resolved with a pre-determined set of rules or sending the information to a default co-user.

The methods and system described herein overcome many of the problems associated with domain names described above. The method and system help to permanently protect and utilize domain name registrations. The method and system help prevent a domain name owner from ever losing valuable domain name rights, reduce the burden and administrative overhead placed on domain name owners and more fully utilize existing and anew rights associated with a domain name registration.

It should be understood that the programs, processes, methods and system described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments including hardware or firmware implementations, or combinations thereof, may alternatively be used, and visa versa.

The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

1-33. (canceled)

34. A method comprising:
receiving a one-time fee payment from a user in exchange for continued, periodic pre-payment of any future renewal fees, automatically by a server network device, required to maintain registration of a first registered domain name with a first domain name registrar;
storing, by the server network device in a database, a record including information associated with the first registered domain name,
the database including a plurality of records, each record corresponding to a respective registered domain name associated with a respective one-time fee payment from a respective user for continued, periodic pre-payment of any respective future renewal fees, automatically by the server network device, required to maintain registration of the respective registered domain name;
automatically generating, by the server network device based on the database, a first list of registered domain names that will expire by a first date unless a respective renewal fee is paid to a respective corresponding domain name registrar by the first date for each registered domain name of the first list,
the first list including the first registered domain name;
automatically paying electronically, by the server network device and by the first date, a first renewal fee to the first domain name registrar for renewing the first registered domain name, without requiring any payment from the user in addition to the one-time fee payment;
determining, by the server network device, that all respective renewal fees for the generated first list of registered domain names were paid to the respective corresponding domain name registrar by the first date;
automatically generating, by the server network based on the database, a second list of registered domain names that will expire by a second date unless a respective renewal fee is paid to a respective corresponding domain name registrar by the second date for each registered domain name of the second list,
the second list including the first registered domain name; and
automatically paying electronically, by the server network device and by the second date, a second renewal fee to the first domain name registrar for renewing the first registered domain name, without requiring any payment from the user in addition to the one-time fee payment.

35. The method of claim 34, further comprising:
prior to receiving the one-time fee payment from the user, receiving, by the server network device, an indication of a first domain name that is not registered; and
registering the first domain name, thereby establishing the first registered domain name.

36. The method of claim 34, wherein the one-time fee payment is further in exchange for registering the first registered domain name with the first domain name registrar.

37. The method of claim 34, further comprising:
prior to receiving the one-time fee payment from the user, receiving, by the server network device, information associated with the first registered domain name, wherein the first registered domain name is a first domain name registered previously by the user with the first domain name registrar.

38. The method of claim 37, wherein receiving the information associated with the first registered domain name comprises:
receiving from the first domain name registrar the information associated with the first registered domain name.

39. The method of claim 37, wherein receiving the information associated with the first registered domain name comprises:
receiving from the user the information associated with the first registered domain name.

40. The method of claim 34, further comprising:
determining, by the server network device, that all respective renewal fees for the generated second list of registered domain names were paid to the respective corresponding domain name registrar by the second date.

41. The method of claim 34, wherein the first domain name registrar does not comprise the server network device.

42. The method of claim 34, further comprising:
issuing a permanent registration certificate to the user.

43. The method of claim 34, further comprising:
automatically using the one-time fee payment to pay all future renewal fees for the first registered domain name registered with the first domain name registrar.

44. The method of claim 34, wherein automatically generating the first list of registered domain names comprises:
generating the first list a predetermined period of time before the first date.

45. The method of claim 34, further comprising:
periodically comparing first respective corresponding renewal dates for each of the plurality of registered domain names stored in the database with second respective corresponding renewal dates stored on a public domain name registrar for each of the plurality of registered domain names to identify any discrepancies between the renewal dates.

46. The method of claim 34, further comprising:
periodically comparing first respective corresponding registration information for each of the plurality of registered domain names stored in the database with second respective corresponding registration information stored on a public domain name registrar for each of the plurality of registered domain names to identify any discrepancies between the registration information, the registration information including at least one of contact information and DNS information.

47. The method of claim 34, wherein the one-time fee payment is added to a financial instrument; and
further comprising:
automatically using interest earned from the financial instrument to pay at least one renewal fee for the first registered domain name.

48. The method of claim 34, further comprising:
issuing to the user an insurance policy covering financial losses associated with the server network device failing to purchase automatically at least one renewal fee for the first registered domain name without requiring any payment from the user in addition to the one-time fee payment.

49. An apparatus comprising:
a processor; and
a computer readable storage system in communication with the processor, the computer readable storage system storing instructions configured so that when executed by the processor, the instructions direct the processor to perform a method comprising:
receiving a one-time fee payment from a user in exchange for continued, periodic pre-payment of any future renewal fees, automatically, required to maintain registration of a first registered domain name with a first domain name registrar;
storing, in a database, a record including information associated with the first registered domain name,
the database including a plurality of records, each record corresponding to a respective registered domain name associated with a respective one-time fee payment from a respective user for continued, periodic pre-payment of any respective future renewal fees, automatically by the server network device, required to maintain registration of the respective registered domain name;
automatically generating, based on the database, a first list of registered domain names that will expire by a first date unless a respective renewal fee is paid to a respective corresponding domain name registrar by the first date for each registered domain name of the first list,
the first list including the first registered domain name;
automatically paying electronically, by the first date, a first renewal fee to the first domain name registrar for renewing the first registered domain name, without requiring any payment from the user in addition to the one-time fee payment;
determining that all respective renewal fees for the generated first list of registered domain names were paid to the respective corresponding domain name registrar by the first date;
automatically generating, based on the database, a second list of registered domain names that will expire by a second date unless a respective renewal fee is paid to a respective corresponding domain name registrar by the second date for each registered domain name of the second list,
the second list including the first registered domain name; and
automatically paying electronically, by the second date, a second renewal fee to the first domain name registrar for renewing the first registered domain name, without requiring any payment from the user in addition to the one-time fee payment.

50. The apparatus of claim 49, the instructions configured so that when executed by the processor, the instructions further direct the processor to perform:
prior to receiving the one-time fee payment from the user, receiving an indication of a first domain name that is not registered; and
registering the first domain name, thereby establishing the first registered domain name.

51. The apparatus of claim 49, wherein the one-time fee payment is further in exchange for registering the first registered domain name with the first domain name registrar.

52. The apparatus of claim 49, further comprising:
prior to receiving the one-time fee payment from the user, receiving information associated with the first registered domain name, wherein the first registered domain name is a first domain name registered previously by the user with the first domain name registrar.

53. The apparatus of claim 49, wherein the one-time fee payment is added to a financial instrument; and
the instructions configured so that when executed by the processor, the instructions further direct the processor to perform:
automatically using interest earned from the financial instrument to pay at least one renewal fee for the first registered domain name.

54. A non-transitory computer readable medium storing instructions configured so that when executed by a computing device, the instructions direct the computing device to perform a method comprising:
receiving a one-time fee payment from a user in exchange for continued, periodic pre-payment of any future renewal fees, automatically by a server network device, required to maintain registration of a first registered domain name with a first domain name registrar;
storing, by the server network device in a database, a record including information associated with the first registered domain name,
the database including a plurality of records, each record corresponding to a respective registered domain name associated with a respective one-time fee payment from a respective user for continued, periodic pre-payment of any respective future renewal fees, automatically by the server network device, required to maintain registration of the respective registered domain name;
automatically generating, by the server network device based on the database, a first list of registered domain names that will expire by a first date unless a respective renewal fee is paid to a respective corresponding domain name registrar by the first date for each registered domain name of the first list,
the first list including the first registered domain name;
automatically paying electronically, by the server network device and by the first date, a first renewal fee to the first domain name registrar for renewing the first registered domain name, without requiring any payment from the user in addition to the one-time fee payment;
determining, by the server network device, that all respective renewal fees for the generated first list of registered domain names were paid to the respective corresponding domain name registrar by the first date;
automatically generating, by the server network based on the database, a second list of registered domain names that will expire by a second date unless a respective renewal fee is paid to a respective corresponding domain name registrar by the second date for each registered domain name of the second list,
the second list including the first registered domain name; and
automatically paying electronically, by the server network device and by the second date, a second renewal fee to the first domain name registrar for renewing the first registered domain name, without requiring any payment from the user in addition to the one-time fee payment.
